(19) United States
(12) Patent Application Publication
(10) Pub. No.: US 2010/0107770 A1
(43) Pub. Date: May 6, 2010

(54) CAPACITIVE PRESSURE SENSOR

(75) Inventors: Bogdan Serban, Leudelange (LU); Philippe Boyer, Boust (FR); Aloyse Schoos, Bertrange (LU)

Correspondence Address: CANTOR COLBURN, LLP, 20 Church Street, 22nd Floor, Hartford, CT, 06103, US

(73) Assignee: IEE INTERNATIONAL ELECTRONICS & ENGINEERING S.A., ECHTERNACH (LU)

(21) Appl. No.: 12/528,855

(22) PCT Filed: Feb. 21, 2008
(86) PCT No.: PCT/EP2008/052106

§ 371 Date: Oct. 5, 2009

(30) Foreign Application Priority Data
Feb. 27, 2007 (US) 11679613

(51) Int. Cl. G01L 9/12; B32B 37/14

(52) U.S. Cl. 73/718; 156/182

(57) ABSTRACT

A capacitive pressure includes a laminated arrangement with a first flexible, electrically insulating carrier film carrying a first capacitor electrode, a second flexible, electrically insulating carrier film carrying a second capacitor electrode and a flexible, electrically insulating spacer film sandwiched between the first and second carrier films, where the spacer film has a through-hole or recess therein, with respect to which the first and second capacitor electrodes are arranged opposite one another, in such a way that the first and second electrodes are brought closer together by resilient bending of the first and/or second carrier film into the through-hole or recess under the action of a compressive force acting on the pressure sensor.

### TECHNICAL FIELD OF THE INVENTION

The present invention generally relates to a capacitive pressure sensor, e.g. for use as an input device for human-appliance interaction (touchpad, keypad, slider, pressure sensing mat, etc.).

### BRIEF DESCRIPTION OF RELATED ART

Capacitive pressure sensors as such are well known in the art. Such a sensor generally comprises a capacitor, whose capacitance varies as a function of pressure. It is, for instance, known to built a capacitive switch, comprising a first capacitor electrode made of bulk metal and a second capacitor electrode also made of bulk metal, arranged at a certain distance from the first capacitor electrode by an insulating foam spacer. As the first and second electrodes are brought closer together under the action of a compressive force acting on the pressure switch, the capacitance of the capacitor increases. An evaluation circuit detects this increase of capacitance. If the capacitance exceeds a certain predefined threshold, the evaluation circuit triggers some action associated with the capacitive switch. Such capacitive switches are, for instance, used in computer mouse buttons.

### BRIEF SUMMARY OF THE INVENTION

The present invention provides a capacitive pressure sensor, which is robust and can be manufactured at low costs.

The capacitive pressure sensor comprises a laminated arrangement with a first flexible, electrically insulating carrier film carrying a first capacitor electrode, a second flexible, electrically insulating carrier film carrying a second capacitor electrode and a flexible, electrically insulating spacer film sandwiched between the first and second carrier films. The spacer film has a through-hole or recess therein, with respect to which the first and second capacitor electrodes are arranged opposite one another, in such a way that the first and second electrodes are brought closer together by resilient bending of the first and/or second carrier film into the through-hole or recess under the action of a compressive force acting on the pressure sensor. The capacitive pressure sensor is advantageously configured and arranged so that a short-circuit between the first and second capacitor electrodes is prevented even for relatively high pressure. This is the case, for instance, if at least one of the first and second capacitor electrodes is arranged on the surface of the respective carrier film that faces away from the spacer film. In this configuration, the carrier layer itself prevents contact between the electrodes. In another suitable configuration, the spacer film does not have a through-hole therein but a recess, whose depth is inferior to the thickness of the spacer film. If the spacer film has a through-hole therein, if the first capacitor electrode is arranged on the surface of the first carrier film that faces the spacer film and if the second capacitor electrode is arranged on the surface of the second carrier film that faces the spacer film, a short-circuit may be avoided by a dedicated electrically insulating layer arranged on at least one of the first and second capacitor electrodes.

An advantage of a laminated capacitive pressure sensor as recited above is that it can be produced with low thickness, e.g. in the range from 0.1 to 1 mm, more preferably in the range from 0.2 to 5 mm. Typically, the carrier films and the spacer film have a thickness ranging from 25 μm to some hundreds of μm. The reduced thickness of such laminated capacitive pressure sensor makes it interesting for a broad range of applications, e.g. in pressure-sensing mats for detecting and/or classifying a passenger on a vehicle seat, in keypads or touchpads for electronic appliances (mobile phone, personal digital assistant, handheld game console, computer, and so forth).

According to a preferred embodiment of the invention, the first and or the second carrier film and/or the spacer film comprises one or more layers made of thermoplastic polymer material, such as e.g. PET, PEN, PI, PEEK, PES, PPS, PSU and mixtures thereof. Combining different materials allows one to tailor the flexibility, shear and tear resistance, and to improve sensor reliability. The electrodes are preferably conductive polymer thick film electrodes, formed by printing of conductive ink onto the first and/or the second carrier film. Preferably, the flexible spacer film is configured as a double-sided adhesive.

Most preferably, the gap between the first and second capacitor electrodes (i.e. the opening or recess) does not comprise a foam material arranged therein but is only filled with gas. Conveniently, this gas is air; nevertheless, other gases (e.g. N₂, Ar, CO₂ or mixtures thereof) are also suitable.

Advantageously, the capacitive pressure sensor comprises an evaluation circuit operatively connected to the first and second capacitor electrodes and configured for determining a quantity indicative of capacitance (and thus of the pressure) between the first and second capacitor electrodes. Preferably, the evaluation circuit is configured for operating in two modes of operation: in the first mode of operation, the evaluation circuit determines a quantity indicative of capacitance between the first capacitor electrode and ground and, in the second mode of operation, the evaluation circuit determines a quantity indicative of capacitance between the first and second capacitor electrodes. Those skilled will appreciate that such a capacitive pressure sensor combines proximity sensing (in the first mode of operation) with pressure sensing (in the second mode of operation)

As will be appreciated, the invention is not limited to a capacitive pressure sensor comprising a single pair of capacitor electrodes, which is of course the simplest embodiment. The first carrier film could carry, for instance, a plurality of first capacitor electrodes, each one of the first capacitor electrodes being arranged opposite a common second capacitor electrode. Alternatively, both the first and the second carrier films could carry a plurality of capacitor electrodes, each one of the capacitor electrodes on the first carrier film being arranged opposite a respective one of the capacitor electrodes on the second carrier film. Other variants for arranging first and second capacitor electrodes (e.g. first and second capacitor electrodes offset with respect to one another; first electrodes arranged in groups, wherein the members of a group are arranged opposite a common second electrode; etc.) are deemed within the reach of those normally skilled in the art.

As will be apparent to those skilled in the art, a capacitive pressure sensor as generally described hereinbefore can be manufactured by applying the first capacitor electrode onto the first flexible carrier film and the second capacitor electrode onto the second flexible carrier film, providing a flexible spacer film with an opening or recess; and laminating together the first first flexible carrier film carrying the first capacitor electrode, the spacer film and the second flexible carrier film carrying the second capacitor electrode in such a way that the first and second capacitor electrodes are arranged opposite one another with respect to the opening or recess.

As shall be appreciated, the carrier films, the spacer the electrodes, as well as any other layers or components of the capacitive pressure sensor according to the present invention may be made of transparent, semi-transparent or translucent material, in such a way that the input device may be back-illuminated and/or positioned on top of a display screen.

### BRIEF DESCRIPTION OF THE DRAWINGS

Further details and advantages of the present invention will be apparent from the following detailed description of several not limiting embodiments with reference to the attached drawings, wherein:

FIG. 1 is a schematic cross-sectional view of a laminated capacitive proximity and pressure sensor, connected to an evaluation circuit;

FIG. 2 is a cross-sectional view of a variant of the capacitive proximity and pressure sensor shown in FIG. 1;

FIG. 3 is an illustration of different examples of electrically insulating patterns;

FIG. 4 is a schematic cross-sectional view of a laminated pressure sensor carried out as a capacitive touchpad;

FIG. 5 is a schematic cross-sectional view of a variant of the capacitive touchpad of FIG. 4;

FIG. 6 is a schematic cross-sectional view of a laminated capacitive touchpad according to another embodiment;

FIG. 7 is a schematic cross-sectional view of a variant of the touchpad represented in FIG. 6;

FIGS. 8a-8c are illustrations of examples of linear layouts for the first capacitor electrodes;

FIGS. 9a-9d are illustrations of examples of circular layouts for the first capacitor electrodes;

FIGS. 10a-10c are illustrations of examples of layouts for the first and second capacitor electrodes for detecting position or movement in 2 dimensions.

It should be noted that the drawings are not to scale. In particular, no scale should be derived from the human finger depicted in certain of the drawings.

### DETAILED DESCRIPTION OF THE INVENTION

FIG. 1 shows a first example of a laminated capacitive proximity and pressure sensor 10. The device comprises first and second carrier films 12, 14, made of substantially flexible, electrically insulating material, such as e.g. PET, PEN, PI or the like. A double-sided adhesive layer 16 is sandwiched as a spacer film between the first and second carrier films 12, 14 so as to keep these apart from one another. The double-sided adhesive layer 16 is provided with an opening 18 therein, which delimits an active zone of the proximity and pressure sensor 10. In the active zone, the first carrier foil 12 carries a first capacitor electrode 20 on the side directed towards the second carrier film 14, while the second carrier film 14 carries a second capacitor electrode 22 on the side directed towards the first carrier film 12. The first and second capacitor electrodes 20, 22 are formed from conductive material (e.g. silver ink) applied directly on the first and second carrier films 12, 14, respectively. The second capacitor electrode has a layer 24 of electrically insulating material (dielectric, e.g. PET, PEN, PI, etc.) formed thereon.

The right-hand side of FIG. 1 shows an evaluation circuit 26 connected to the first and second capacitor electrodes 20, 22 by leads 28, 30. The evaluation circuit 26 comprises a microprocessor, an application-specific integrated circuit (ASIC) or a programmable chip, configured so as to operate in at least a first and a second mode of operation.

The evaluation circuit 26 determines, while in the first mode of operation, a quantity indicative of a capacitance between the first capacitor electrode 20 and ground and, while in the second mode of operation, a quantity indicative of a capacitance between the first capacitor electrode 20 and the second capacitor electrode 22. The evaluation circuit 26 may operate in the first mode of operation before and/or after operating in the second mode of operation. The evaluation circuit 26 may cyclically switch between the modes of operation, e.g. several times per second. Preferably, however, the evaluation circuit 26 remains in the proximity-sensing mode (first mode) until the proximity of a body having an electric-field-changing property is detected. Alternatively, the evaluation circuit 26 could remain in the pressure-sensing mode (second mode) until a force or pressure exceeding a predefined threshold has been detected. It shall be noted that the recited “quantity indicative of a capacitance” can be any physical quantity that is linked to the capacitance by the laws of physics, such as, for instance, amplitude and/or phase of a current, amplitude and/or phase of a voltage, charge, impedance, and so forth.

The first mode of operation is associated to sensing an object having an electric-field-influencing property in the vicinity of the first capacitor electrode 20, e.g. a user's finger 32, a conductive stylus, or the like. In the first mode of operation, the evaluation circuit 26 keeps the first and second capacitor electrodes 20, 22 essentially at the same electric potential, so that the electric field substantially cancels between the first and second electrodes 20, 22. The second electrode 22 thus acts as a driven shield for the first electrode 20 and the sensitivity of the latter is directed away from the second electrode 22. If an oscillating voltage is applied to the first capacitor electrode 20, an oscillating electric field to ground is built up. The object to be sensed modifies the capacitance between the first capacitor electrode 20 and ground, which is sensed by the evaluation circuit 26. It should be noted that in the first mode of operation detecting the proximity of the object to be sensed does not require the object touching or being in contact with the proximity and pressure sensor 10.

The second mode of operation is associated with sensing pressure exerted on the sensor 10 by some kind of actuator, such as e.g. the user's finger 32 or stylus (in order to detect the amount of pressure exerted upon the active zone of the sensor 10). In the second mode of operation, the evaluation circuit 26 essentially determines the capacitance of the capacitor formed by the first and the second capacitor electrodes 20, 22. It is well known that the capacitance of a capacitor depends upon the distance between its electrodes. In the illustrated case, the distance between the first and second capacitor electrodes 20, 22 decreases with increasing pressure exerted upon the pressure sensor 10. As a consequence, the capacitance between the capacitor electrodes increases, which is detected by the evaluation circuit 26.

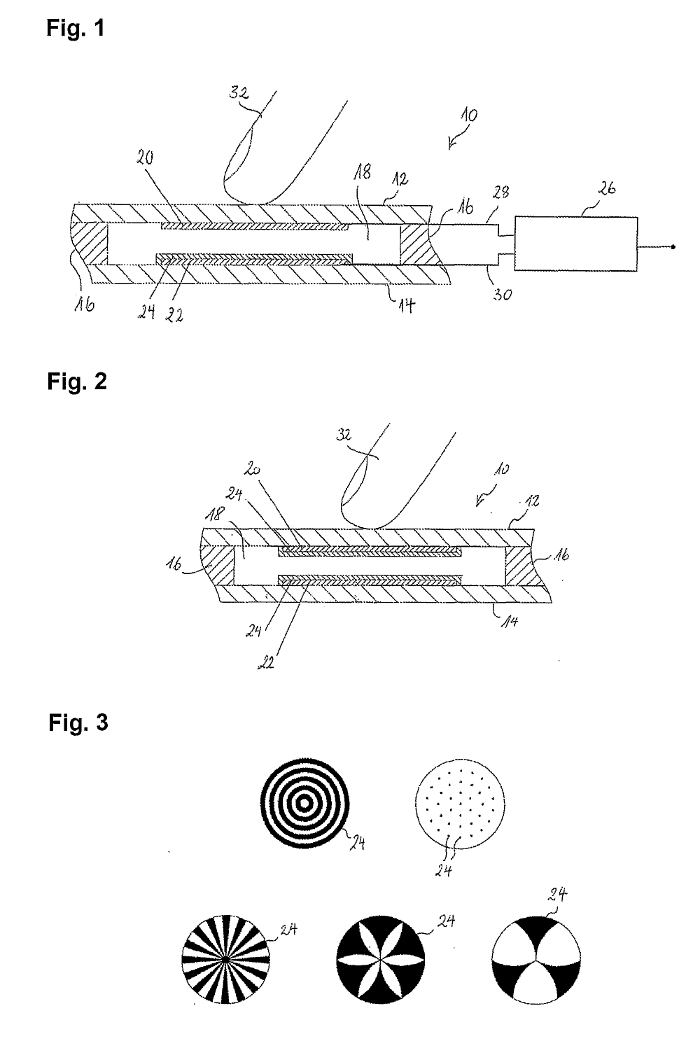

FIG. 2 shows a variant of the proximity and pressure sensor of FIG. 1. The construction is the same, except that the first capacitor electrode 20, like the second capacitor electrode 22, has formed thereon a layer 24 of electrically insulating material. Those skilled will appreciate that patterning one of the electrically insulating layers 24 allows tailoring the response of the proximity and pressure sensor 10 in the second mode of operation. As long as the electrically insulating layers 24 are spaced from one another (i.e. for low pressures exerted by the user) the pattern has no significant influence on sensor response. However, as the pressure increases the electrically insulating layers 24 come into contact and a contact surface forms. Patterning the insulating layer 24 thus results in that the minimum distance between the first and second electrodes 20, 24 is not constant on the contact surface. Accordingly, the capacitance increase is different from the case where the insulating layers 24 are both of uniform thickness. Examples of patterned insulating layers 24 are shown in FIG. 3.

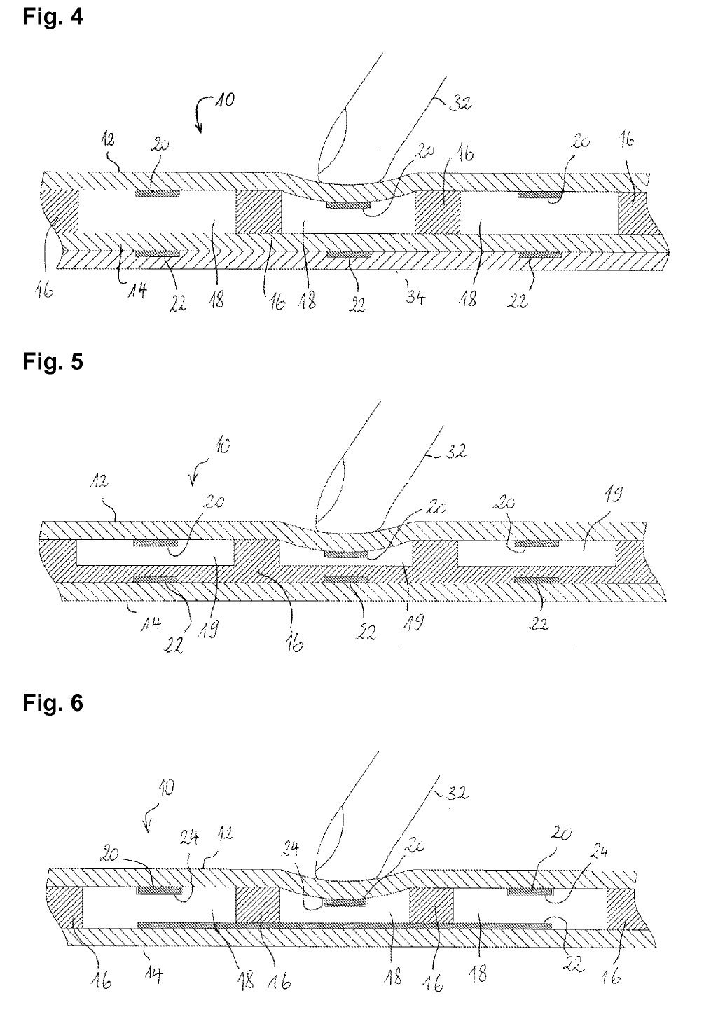

FIGS. 4 to 6 show various examples of a capacitive pressure sensor 10 carried out as a touchpad. The touchpad 10 of FIG. 4 comprises a laminated structure of a first carrier film 12, a second carrier film 14, a spacer 16, sandwiched between the first and second carrier films 12, 14 so as to keep them spaced apart, and a protective thermoplastic film 34. The spacer 16 has a matrix-like arrangement of openings 18 therein, which define keys of the touchpad 10. To each key is associated a pair of a first capacitor electrode 20 and a second capacitor electrode 22 arranged on the first and second carrier films 12, 14, respectively. Each first capacitor electrode 20 is arranged opposite its second-capacitor-electrode counterpart 22, with respect to the associated opening 18 of the spacer 16. The first capacitor electrodes 20 are arranged on the side of the first carrier film that faces the spacer film 16 and the second carrier film 14. The second capacitor electrodes 22, however, are arranged on the side of the second carrier film that faces away from the spacer film 16 and the first carrier film 12. The protective thermoplastic film 34 is laminated onto that same side of the second carrier film, so to prevent contamination of the second capacitor electrodes. In the embodiment of FIG. 4, a short-circuit between any one of the first capacitor electrodes and the corresponding second capacitor electrode is effectively prevented due to the presence of the insulating second carrier film 14 between the first and second capacitor electrodes.

In the touchpad 10 of FIG. 5, the first and second capacitor electrodes 20, 22 are arranged on the interior sides of the first and second carrier films 12, 14, respectively. Instead of openings carried out as through-holes as in FIGS. 1, 2 and 4, the spacer 16 of FIG. 5 has a plurality of recesses 19 therein, whose depth is inferior to the thickness of the spacer. As a result, the second capacitor electrodes 22 are separated from the first capacitor electrodes not only by gas-filled gaps but also by those portions of the spacer film 16 that define the bottom of recesses 19.

FIG. 6 shows a touchpad 10, in which the comprises a laminated arrangement of a first carrier film 12, a second carrier film 14 and a spacer film 16, sandwiched between the first and second carrier films 12, 14 so as to keep these spaced apart. The spacer 16 has openings 18 therein, which define the active zones (“keys”) of the touchpad 10. To each key is associated a first capacitor electrode 20 arranged on the first carrier film 12. A common second capacitor electrode 22 extends over all the keys of the touchpad 10. The touchpad 10. To prevent short-circuits each one of the first capacitor electrodes is covered with a thin electrically insulting layer 24.

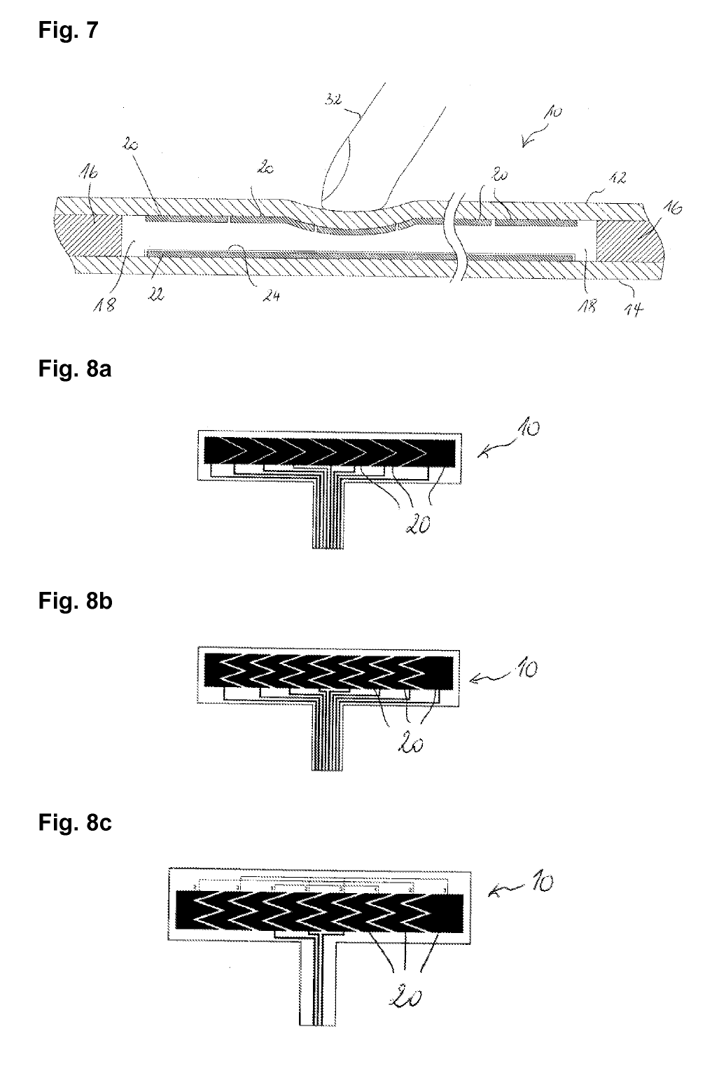

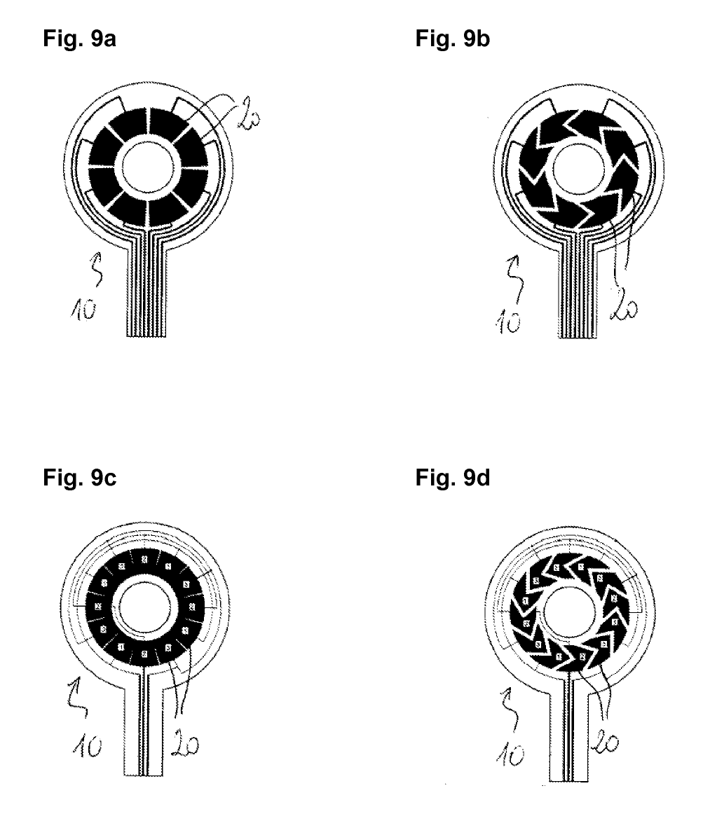

FIG. 7 shows a variant of the touchpad of FIG. 6. In this variant, it is the common second capacitor electrode 22, which is covered with a thin electrically insulating layer. Moreover, the touchpad 10 of FIG. 7 has an opening 18 that defines a common active zone, in which at least some of the first capacitor electrodes 20 are arranged. The present variant is especially suitable for applications in which a user presses on the first and/or the second carrier film and performs a continuous sliding movement while maintaining the pressure. It should be noted that the first capacitor electrodes could be arranged along a line, a curve or in a grid-like configuration. FIGS. 8a-8c and 9a-9d show several possible layouts of the first capacitor electrodes in top view.

The touch pads of FIGS. 4-7 are advantageously connected to an evaluation circuit (not shown), which determines, in a first mode of operation, a quantity indicative of capacitance between individual ones of the first capacitor electrodes 20 and ground and, in a second mode of operation, a quantity indicative of a capacitance between individual ones of the first capacitor electrodes 20 and the corresponding second capacitor electrode(s).

In the first mode of operation, the position of a user's finger could, for instance be detected by determining, for each one of the first capacitor electrodes, the quantity indicative of capacitive coupling between this electrode and ground. The position may e.g. be computed as the centroid of the positions of the first capacitor electrodes, weighed with the corresponding quantity indicative of capacitance. The first mode of operation is suitable, for instance, when the user controls a cursor (e.g. on the display of an appliance). The second mode of operation is associated to actuation of a key of the touchpad, e.g. by a user's finger or a stylus.

In FIGS. 8a-8c the first capacitor electrodes are arranged along a straight line, whereas in FIG. 9a-9d, they are arranged in a circle. In the arrangements of FIGS. 8a, 8b, 9a and 9b, the first capacitor electrodes 20 are separately connectable to an evaluation circuit. Accordingly, it is possible to detect the position of the user's finger in both the first and second modes of operation. In the arrangements of FIG. 8c, 9c and 9d, the first capacitor electrodes are not separately connected to the control circuit. Instead, there are three groups of first capacitor electrodes 20. The first capacitor electrodes 20 of each group are conductively interconnected. Along the active zone, a first capacitor electrode of the first group is followed by one of the second group, which is, in turn, followed by one of the third group, after which the succession starts again with a first capacitor electrode of the first group. In these configurations, detection of the (absolute) position of a user's finger or stylus is not possible. Nevertheless, such slider can detect a movement of the user's finger or stylus (in both modes of operation). When the user's finger or stylus moves from the left to the right in FIG. 8c or in the clockwise sense in FIGS. 9c and 9d, the succession of the groups of first capacitor electrodes that have increased capacitive coupling to ground or to the second capacitor electrode is 2-3-1 (and cyclically continued). When the user's finger moves from the right to the left in FIG. 8c or in the clockwise sense in FIGS. 9c and 9d, the succession of the groups of first capacitor electrodes that have increased capacitive coupling to ground or to the second capacitor electrode is 3-2-1 (and cyclically continued). Given the reduced number of external connectors, the configurations of FIGS. 8c, 9c and 9d is particularly interesting if the absolute position does not need to be known, e.g. for navigating through list-based menus (scrolling through a list of items displayed and selecting an item to enter a sub-menu or start a certain function). The action of selecting an item from the list can e.g. take place when the user presses on the slider with a force that causes the quantity indicative of capacitance between the first and second capacitor electrodes to exceed the predetermined threshold.

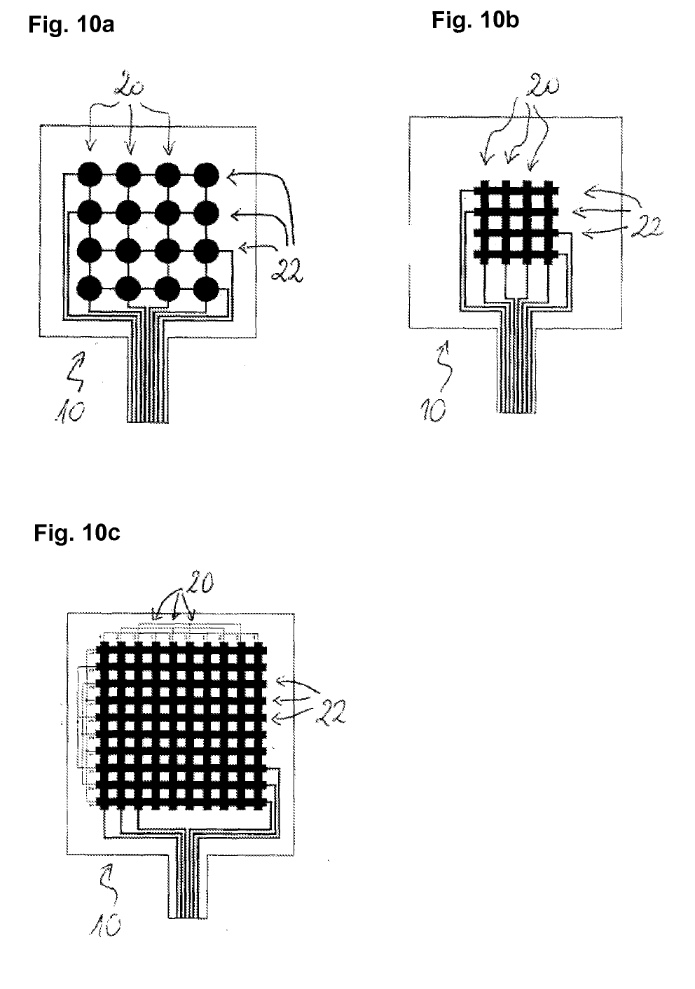

FIGS. 10a-10c schematically show possible layouts for the first and second capacitor electrodes for detecting position or movement in 2 dimensions.

In FIGS. 10b and 10c, the electrodes 20, 22 are configured as elongated conductive strips arranged in parallel. The first capacitor electrodes 20 extend crosswise to the second capacitor electrodes 22 so as to form a grid-like configuration.

In FIG. 10a, the electrodes are configured as individual discs disposed in rows and columns; to each first capacitor electrode 20 is associated, in facing relationship with respect to the spacer. The first capacitor electrodes are conductively interconnected along the columns and the second capacitor electrodes are conductively interconnected along the rows.

In FIGS. 10a and 10b, each line or column is separately connectable to a control circuit. Accordingly, it is possible to detect the position of the user's finger or stylus compressing locally pressure sensor 10 by determining the amount of capacitive coupling between the rows and the columns.

In FIG. 10c, the rows and columns are not separately connectable to a control circuit. Instead, there are three groups of rows and three groups of columns. The electrodes of each group are conductively interconnected. In direction along the columns, a row of the first group is followed by one of the second group, which is, in turn, followed by one of the third group, after which the succession starts again with a row of the first group. Similarly, in direction along the rows, a column of the first group is followed by one of the second group, which is, in turn, followed by one of the third group, after which the succession starts again with a column of the first group. A touchpad as shown in FIG. 10c is not capable of detecting (absolute) position of the point of application of a force. Nevertheless, such touchpad can detect movement of the point of application of a force. The direction of the movement perpendicular to the rows can be determined from the succession of the groups of columns, which have increased capacitive coupling to the rows on the other carrier film. Likewise, the direction of the movement perpendicular to the columns can be determined from the succession of the groups of rows, which have increased capacitive coupling to the columns on the other carrier film.

1. A capacitive pressure sensor, comprising
a first capacitor electrode and a second capacitor electrode spaced from the first capacitor electrode, said first and second capacitor electrodes being configured to be resiliently brought closer together under the action of a compressive force acting on the pressure sensor,
as well as an evaluation circuit operatively connected to said first and second capacitor electrodes and configured to determine a quantity indicative of capacitance between said first and second capacitor electrodes,
wherein said capacitive pressure sensor comprises a laminated arrangement with a first flexible, electrically insulating carrier film carrying said first capacitor electrode, a second flexible, electrically insulating carrier film carrying said second capacitor electrode and a flexible, electrically insulating spacer film sandwiched between said first and second carrier films, said spacer film having a through-hole or recess therein, with respect to which said first and second capacitor electrodes are arranged opposite one another in such a way that said first and second electrodes can be brought closer together by resilient bending of said first and/or second carrier film into said through-hole or recess under the action of a compressive force acting on the pressure sensor.

2. The capacitive pressure sensor as claimed in claim 1, wherein at least one of said first and said second carrier film and said spacer film comprises one or more layers made of thermoplastic polymer material.

3. The capacitive pressure sensor as claimed in claim 1, wherein said opening or recess is gas-filled.

4. The capacitive pressure sensor as claimed in claim 1, wherein said laminated arrangement has a thickness ranging from 0.1 to 1 mm.

5. The capacitive pressure sensor as claimed in claim 1, wherein said evaluation circuit operatively connected to said first and second capacitor electrodes is configured for operating in a first mode of operation and a second mode of operation, said evaluation circuit determining, while in said first mode of operation, a quantity indicative of capacitance between said first capacitor electrode and ground and, while in said second mode of operation, a quantity indicative of capacitance between said first and second capacitor electrodes.

6. The capacitive pressure sensor as claimed in claim 1, wherein said flexible spacer film is configured as a double-sided adhesive.

7. The capacitive pressure sensor as claimed in claim 1, wherein at least one of the first and second capacitor electrodes is arranged on the surface of the respective carrier film that faces away from the spacer film.

8. The capacitive pressure sensor as claimed in claim 1, wherein said spacer film has a through-hole therein, wherein said first capacitor electrode is arranged on the surface of the first carrier film that faces the spacer film, wherein said second capacitor electrode is arranged on the surface of the second carrier film that faces the spacer film and wherein at least one of the first and second capacitor electrodes has an electrically insulating layer arranged thereon so as to prevent a short-circuit when said first and second capacitor electrodes are brought closer together.

9. The capacitive pressure sensor as claimed in claim 1, wherein said first carrier film carries a plurality of first capacitor electrodes, each one of said first capacitor electrodes being arranged opposite said second capacitor electrode.

10. The capacitive pressure sensor as claimed in claim 1, wherein said first carrier film carries a plurality of first capacitor electrodes, wherein said second carrier film carries a plurality of second capacitor electrodes, each one of said second capacitor electrodes being arranged opposite a respective one of said first capacitor electrodes.

11. A method for producing a capacitive pressure sensor, said capacitive pressure sensor to be produced, comprising
a first capacitor electrode and a second capacitor electrode spaced from the first capacitor electrode, said first and second capacitor electrodes being configured to be resiliently brought closer together under the action of a compressive force acting on the pressure sensor,
as well as an evaluation circuit operatively connected to said first and second capacitor electrodes and configured to determine a quantity indicative of capacitance between said first and second capacitor electrodes, wherein said capacitive pressure sensor comprises a laminated arrangement with a first flexible, electrically insulating carrier film carrying said first capacitor electrode, a second flexible, electrically insulating carrier film carrying said second capacitor electrode and a flexible, electrically insulating spacer film sandwiched between said first and second carrier films, said spacer film having a through-hole or recess therein, with respect to which said first and second capacitor electrodes are arraged opposite one another in such a way that said first and second electrodes can be brought closer together by resilient bending of said first and/or second carrier film into said through-hole or recess under the action of a compressive force acting on the pressure sensor
wherein said method comprises:
applying said first capacitor electrode onto said first flexible carrier film and said second capacitor electrode onto said second flexible carrier film;
providing a flexible spacer film with an opening or recess; and
laminating together said first first flexible carrier film carrying said first capacitor electrode, said spacer film and said second flexible carrier film carrying said second capacitor electrode in such a way that said first and second capacitor electrodes are arranged opposite one another with respect to said opening or recess; and
operatively connecting to said first and second capacitor electrodes an evaluation circuit configured to determine a quantity indicative of capacitance between said first and second capacitor electrodes.

12. A capacitive pressure sensor, comprising
a first capacitor electrode and a second capacitor electrode spaced from the first capacitor electrode, said first and second capacitor electrodes being configured to be resiliently brought closer together under the action of a compressive force acting on the pressure sensor,
as well as an evaluation circuit operatively connected to said first and second capacitor electrodes and configured to determine a quantity indicative of capacitance between said first and second capacitor electrodes,
wherein said capacitive pressure sensor comprises a laminated arrangement with a first flexible, electrically insulating carrier film carrying said first capacitor electrode, a second flexible, electrically insulating carrier film carrying said second capacitor electrode and a flexible, electrically insulating spacer film sandwiched between said first and second carrier films, said spacer film having a through-hole or recess therein, with respect to which said first and second capacitor electrodes are arranged opposite one another in such a way that said first and second electrodes can be brought closer together by resilient bending of said first and/or second carrier film into said through-hole or recess under the action of a compressive force acting on the pressure sensor,
wherein at least one of said first and said second carrier films comprises one or more layers made of thermoplastic polymer material and wherein said flexible spacer film is configured as a double-sided adhesive.

13. The capacitive pressure sensor as claimed in claim 12, wherein said opening or recess is gas-filled.

14. The capacitive pressure sensor as claimed in claim 12, wherein said laminated arrangement has a thickness ranging from 0.1 to 1 mm.

15. The capacitive pressure sensor as claimed in claim 12, wherein said evaluation circuit operatively connected to said first and second capacitor electrodes is configured for operating in a first mode of operation and a second mode of operation, said evaluation circuit determining, while in said first mode of operation, a quantity indicative of capacitance between said first capacitor electrode and ground and, while in said second mode of operation, a quantity indicative of capacitance between said first and second capacitor electrodes.

16. The capacitive pressure sensor as claimed in claim 12, wherein said flexible spacer film is configured as a double-sided adhesive.

17. The capacitive pressure sensor as claimed in claim 12, wherein at least one of the first and second capacitor electrodes is arranged on the surface of the respective carrier film that faces away from the spacer film.

18. The capacitive pressure sensor as claimed in claim 12, wherein said spacer film has a through-hole therein, wherein said first capacitor electrode is arranged on the surface of the first carrier film that faces the spacer film, wherein said second capacitor electrode is arranged on the surface of the second carrier film that faces the spacer film and wherein at least one of the first and second capacitor electrodes has an electrically insulating layer arranged thereon so as to prevent a short-circuit when said first and second capacitor electrodes are brought closer together.

19. The capacitive pressure sensor as claimed in claim 12, wherein said first carrier film carries a plurality of first capacitor electrodes, each one of said first capacitor electrodes being arranged opposite said second capacitor electrode.

20. The capacitive pressure sensor as claimed in claim 12, wherein said first carrier film carries a plurality of first capacitor electrodes, wherein said second carrier film carries a plurality of second capacitor electrodes, each one of said second capacitor electrodes being arranged opposite a respective one of said first capacitor electrodes.
